(19) United States
(12) Patent Application Publication
(10) Pub. No.: US 2013/0304525 A1
(43) Pub. Date: Nov. 14, 2013

(54) METHOD FOR DEVELOPING INTERACTIVE PRE-FABRICATED CINEMA VENUES

(71) Applicant: Interactive Cine Parlor, LLC, San Jose, CA (US)

(72) Inventor: Dennis Skaggs, San Jose, CA (US)

(21) Appl. No.: 13/887,183

(22) Filed: May 3, 2013

Related U.S. Application Data
(60) Provisional application No. 61/642,396, filed on May 3, 2012.

(51) Int. Cl. G06Q 10/02; E04H 3/22

(52) U.S. Cl. CPC G06Q 10/02; E04H 3/22
USPC 705/5; 52/6

(57) ABSTRACT

An interactive digital cinema with at least one pre-fabricated auditorium room with state of the art wall-to-wall screen, a multichannel digital sound system including a sound processor having a digital sound equalization system and a surround sound speaker system; and an online booking system for accepting and processing a general public booking for a featured digital event to be put on in the digital cinema.

### CROSS REFERENCES TO RELATED APPLICATIONS

The present application claims the benefit of U.S. Provisional Patent Application Ser. No. 61/642,396, filed May 3, 2012.

### STATEMENT REGARDING FEDERALLY SPONSORED RESEARCH OR DEVELOPMENT

Not applicable.

### THE NAMES OR PARTIES TO A JOINT RESEARCH AGREEMENT

Not applicable.

### INCORPORATION BY REFERENCE OF MATERIAL SUBMITTED ON A COMPACT DISC

Not applicable.

### BACKGROUND OF THE INVENTION

1. Field of the Invention

The present invention relates generally to a method of building, managing, and operating a pre-fabricated cinema venue specifically designed for less marketed, low budget movies, and independent films, as well as on-demand blockbuster films all available via a website or other online tools readily available through a number of providers and in a number of social networks.

2. Background Discussion

Keeping pace with developments in media and communications technologies is challenging. On the forefront of the many rapidly evolving technologies, there are now several new ways to deliver and view the customary 90-minute photoplay (movie, documentary, and so forth), as well as new ways to see new and innovative program content. Much of this was not even imaginable only 20 years ago, and had it been imaginable even in general terms, the realities and the particulars would have exceeded the imaginings. Yet, of all the industries allied to the entertainment industries, exhibition has been one of the slowest to adapt.

Day and date engagements with Video on Demand (“VOD,” in which a first run film opening in a movie theater is also made available for downloading at the same time), the soft market of home DVD/Blu Ray purchases and rentals, and the highly competitive business of streaming content into viewers' homes [Wii, Apple TV, Roku, etc.] or to connected devices such as cell phones or tablet computers (e.g, an iPad) now provide a competitive challenge to first run engagements in movie theaters. And just as music downloading has reshaped the music recording industry, the way movies are viewed has changed the motion picture industry. It all casts a gloomy picture for what is characterized as “Exhibition,” except for one very important qualification borne, seemingly, of a fundamental human need: people want to get out of their home environment and join others in social activities. “The Movies” have been, and continue to be, an affordable, fun, and surprisingly social way to spend time with friends and strangers.

Motion pictures deepen our experience of life in unique ways. It may well be that a picture is worth a thousand words; if so, it is true enough to be said that a motion picture is worth a million. Nothing can compress time so effectively, so artistically. And with hundreds of thousands of titles available throughout the world, movies will endure as a form of entertainment, education, infotainment, and social focus. With companies such as Netflix, YouTube, Hulu, or the more conventional distributors of motion pictures such as Criterion or Swank, a vast library of content exists today, and it is steadily and ineluctably growing.

One of the more popular current activities in some clubs and organizations is to meet to view films collectively, with discussions held afterward. Many groups gather in living rooms to watch movies on a residential media system, because it is cost prohibitive to rent a movie theater or to have theater management cater to the needs of a small group. Further, post-viewing discussions are more rewarding and effective in small groups, and the inventive theater auditorium, with its small size, state of the art projection and sound systems, custom booking for tens of thousands of available titles, and distraction free viewing is an ideal venue for this kind of organization.

### BRIEF SUMMARY OF THE INVENTION

The present invention includes the structural design and interactive programming of a theater auditorium that has 24 seats with state-of-the-art wall-to-wall image and multichannel digital sound. There may be 10 to 15 auditoriums combined and physically configured in a complex, which may include an elaborate food and services concession for walk-in sales. The overall experience bears similarities to a conventional movie complex, but there are several key differences that create a new and exciting business that fully exploits technologies only recently made available. The following elements combine to provide the new interactive system and method of the present invention:

Using the inventive system and method, patrons and prospective patrons are able to “book” a favorite film from a website, mobile device, voice activated call center, or other interactive means, such as a theatrical-on-demand service, eg., TUGG®. Patrons can pick the title, the date and the time for the showing. They can also define the resolution and cost, then purchase tickets and decide if the event will be a private screening or open to the general public. [TUGG is a trademark of Tugg Inc., dba Tugg Labs, of Austin, Tex.]

If the photoplay showing will be open to the public, the title chosen by the patron becomes part of the show slate, where the title is then advertised through various outlets, including but not limited to various social networks such as Facebook, Twitter, and the like. Others who review the show slate (either on-line or as walk-up patrons) can then decide whether to buy tickets for the film chosen by another patron.

If an auditorium room within the Cine Parlor theater complex sells out, another room then goes on sale. When all rooms are “sold out,” a different show time then goes on sale. Pre-sales are brisk in order to secure a showing on the desired night.

Non-scheduled rooms may also be used to house a GAMESTOP® or other computer game retail outlet. The inventive interactive theater is also a “cyber bowling alley” where people meet after work to play video games and socialize. With HD resolution, 3-D images on a wall-to-wall screen with discreet multichannel sound, the movie complex provides a state-of-the art 21st century gaming center. [GAMESTOP® is a registered trademark of Game Stop, Inc., of Grapevine, Tex.]

With high speed broadband, each auditorium and theater complex provide a highly interactive venue. Webinars can be booked, where a host from nearly any place on the planet can disseminate information with audio and video feedback. Corporate meetings can be conducted remotely at any place in which an interactive digital theater complex is located. Talking therapies of various kinds can be conducted with instant feedback. Since most business activity is conducted during regular business hours, and because entertainment is typically “consumed” at night, the Cine Parlor can be a multi-venue complex serving the community at least 12 hours of every day.

The interactive theater is designed to be a family oriented destination with video games and movies. Concession can offer energy drinks on tap, but preferably alcohol sales are not included. In this way the complex will appeal to all ages and serve as an alternative to venues in which adults go out to drink even when children are present. By the same token, the inventive theater complex thus does not compete with establishments serving alcoholic beverages, enabling marketing tie-ins with neighboring clubs and bars.

Conventional movie theaters and movie theater companies maintain business relationships with motion picture distributors through a model film rental booking agreement. It is common to include a term in the agreement whereby a minimum booking guarantee is waived or placed as a credit against future bookings and a percentage settlement statement—where the tickets sold are recorded and the film rental is paid to the distributor. In the case of the inventive model, consumer-based distributors such as Netflix, YouTube, and Hulu, can work jointly with the Cine Parlor business to deliver licensed content.

The inventive theater and theater complex can also serve as a viable venue for first run engagements of less marketed, low budget movies. Independent filmmakers will have an outlet for their works in a legitimate venue, and due to the small size of the rooms, it will be an affordable “four-wall” engagement. The cost to rent the rooms will be lower than a conventional movie theater, and a “regular run” of the independent production will make it affordable to new and struggling filmmakers.

Responding to the times and trends, the inventive system and method presents patrons with the option to “rent” an auditorium by the hour to play video games. “Spectator” seats can also be purchased by those who simply wish to watch the play action. Talent comes in many ways and is best demonstrated in tournaments. For instance, a Cine Parlor in California could play in real time against a group in New York or even in another country and on another continent. This would be popular and profitable. By securing the rights of the gaming author's intellectual property by paying appropriate royalties, there will be incentives for creating more games designed for use in the environment provided by the inventive system.

The system and method of the present invention is especially well-suited for use on cruise ships. It is customary for cruise lines to offer VOD services in state rooms. However, the state rooms are small and cannot accommodate larger parties of people to socialize and enjoy high quality video and sound as well as the ability to choose particular videos from a database of content including tens of thousands of releases. Thus, the portability of the inventive theater structure also makes it ideal for cruise ship implementation. The size of the theater is also ideal since it does not require large amounts of space, which are at a premium on a cruise liner.

The foregoing summary broadly sets out the more important features of the present invention so that the detailed description that follows may be better understood, and so that the present contributions to the art may be better appreciated. There are additional features of the invention that will be described in the detailed description of the preferred embodiments of the invention which will form the subject matter of the claims appended hereto.

### BRIEF DESCRIPTION OF SEVERAL VIEWS OF THE DRAWINGS

The invention will be better understood and objects other than those set forth above will become apparent when consideration is given to the following detailed description thereof. Such description makes reference to the annexed drawings wherein:

Such description makes reference to the annexed drawings wherein:

FIG. 1 is a schematic side perspective view showing the elevation and screen size proportions for a standard 24-seat auditorium and theatre, using a screen size of up to 16 feet in width by 9 feet in height;

FIG. 2 is a highly schematic top plan view showing a typical floor plan for a theatre (or “Cine Parlor” as termed herein) with 23 seats+1 HC, including a “pop-up” seat exists below the HC location allowing for a max of 24 seats per auditorium; and

FIG. 3 is a block diagrammatic flow chart showing the inventive method steps involved in booking a feature for general public patrons.

### DETAILED DESCRIPTION OF THE INVENTION

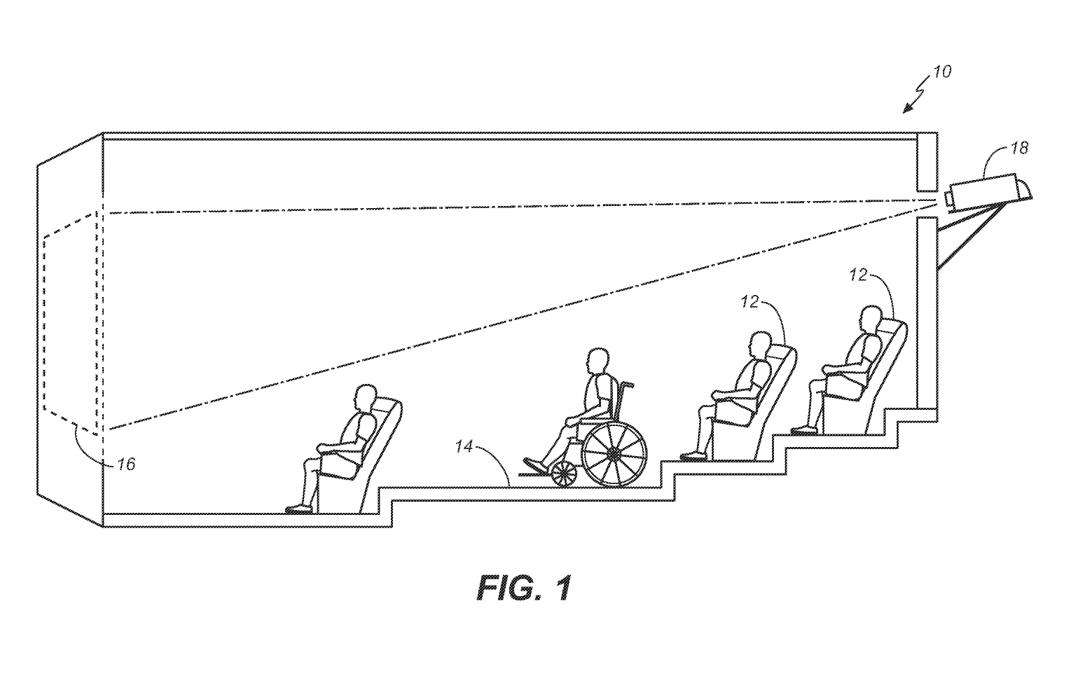

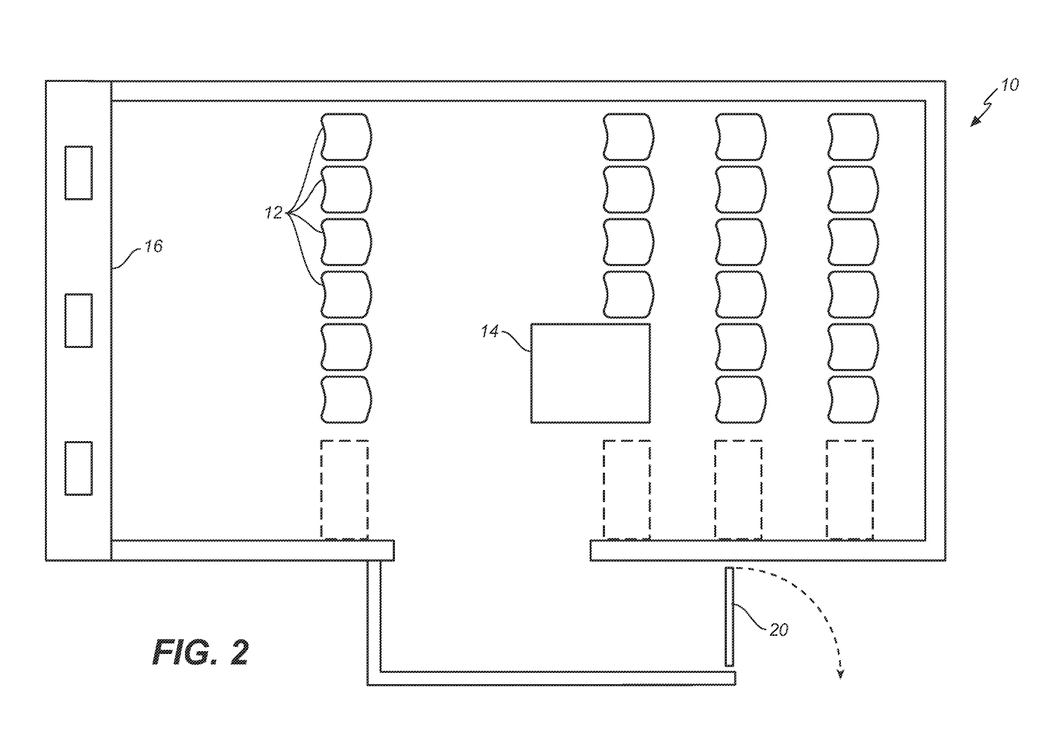

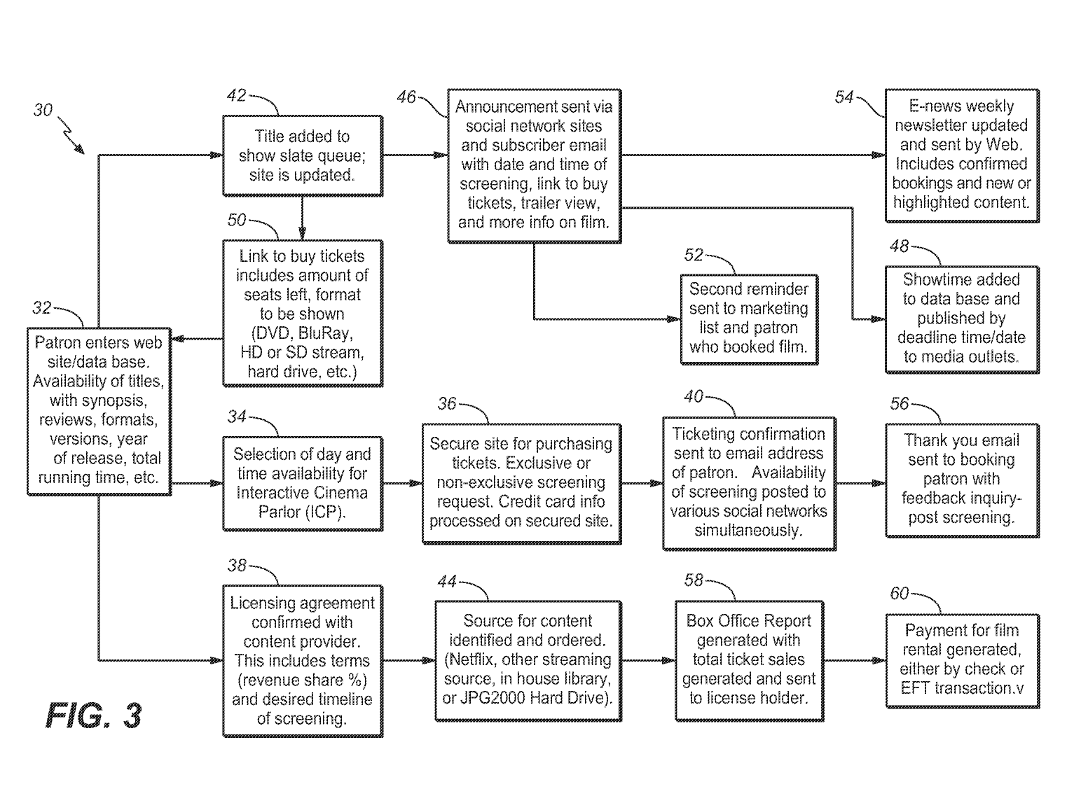

Referring to FIGS. 1 through 3, wherein like reference numerals refer to like elements in the various views, there is illustrated therein a new and improved interactive digital cinema and theater system, which bears the proprietary name of “Cine Parlor,” and generally denominated 10 in FIGS. 1-2. Also illustrated are the method steps for accepting and processing general public bookings for a feature film to be shown using the digital cinema of the present invention, see FIG. 3, where the method is generally denominated by reference number 30.

Thus, and now referring to FIGS. 1-2, the second aspect of the invention involves the physical construction of the cine parlor auditorium, which will be pre-fabricated, with designs that address retrofitting an existing space or new construction. The standard size of each auditorium 10 includes room for 24 seats 12 plus a space 14 for one Americans with Disabilities Act (“ADA”) seat that complies with Uniform Building Code (“UBC”) specifications. The seats are designed to maximize plush, rocking high back seating in a “mini stadium” environment that incorporates site lines and acoustics consistently superior to current movie theater auditoriums. This is achieved by factory built computer designs. Placement of speakers, screen 16, and seating complement the room and space acoustics before the auditorium package leaves the factory and can be tuned for optimal performance during the installation process. The auditorium can incorporate non perforated solid silver screens, increasing the resolution and brightness of the image. State-of-the-art or Digital Cinema Initiatives compliant projectors or equivalent projectors 18 are used as well as high end audio processors, power amps and stage speakers that complement the design. All seats—both in the front row as well as the rear row are good seats. Additions such as D-Box style motion seats can be integrated into the Cine Parlor construction.

The following elements make up the preferred embodiment of the invention covering the inventive auditorium construction.

A non-perforated silver screen (without holes). This increases both resolution and light output along with increasing 3D effects. It increases the life of the bulb used to run the projection system, since the bulb can be operated at low amperage. The screen will also be mounted to the wall with flush wall mounted speakers, thereby saving space.

Since the rooms consist of pre-fabricated components, only one sound equalization (EQ) system is needed, and it can be downloaded into the digital sound processor before it is shipped to the site for installation. This not only saves money, but the finished acoustic product is more accurate and consistent, since it need not be accomplished in the field. A factory performed EQ will also ensure that every seat has perfect, state-of-the-art sound.

The design incorporates a “pop-up’ seat normally stored in the floor boards of the parlor where a handicap space is located. With minimal effort, the seat can “pop up” when the handicap space is not required. This maintains a total of 24 seats for the auditorium, keeping it within UBC codes for minimal egress and handicap spaces. A larger seat can be placed in the back row of the auditorium to accommodate large and/or obese patrons.

Prefabricated panels have recesses for surround speakers, so placement and concealment creates a modern, non-cluttered design. Panels are engineered to acoustically absorb, reflect, baffle, and otherwise manage sound waves inside and prevent sounds from escaping.

The design of the parlors include an expandable component, wherein the size of the auditorium can be doubled from 24 seats to 48 seats. By combining two seating sections (auditoriums have mirrored entrances 20, both left and right), with appropriate and UBC compliant egress modification, the room size is doubled. With the standard 24-seat room, the screen is wall-to-wall and has an adjustable top masking for flat, scope, and other various images. The expandable 48-seat version also includes a wall-to-wall screen, but with side moveable and adjustable masking

Referring next to FIG. 3, there is shown in flow diagrammatic form the method steps 30 involved in accepting and processing a general public booking for a feature film to be shown using the digital cinema of the present invention.

First, at box 32, a patron enters the Cinema Parlor™ web site/data base. There, he or she is shown the film titles that are available for booking, with a synopsis, various reviews by viewers and film critics, film formats, releases and versions, the year of release, the total running time, and so forth.

At box 34, the patron selects the day and time availability for Interactive Cinema Parlor (ICP). The patron is then directed 36 to a secure site for purchasing tickets, where he or she is asked whether the requested screening will be exclusive or non-exclusive. Credit card information is processed on this secure site.

Concurrently or nearly concurrently, at box 38 the licensing agreement is confirmed with a content provider, which includes the terms of revenue sharing, and the desired timeline of screening is also communicated to the content provider.

At step 40, a ticketing confirmation is sent to the email address of the patron, and the availability of the screening is simultaneously posted to various social networks.

At step 42, the title of the film scheduled for screening is added to the show slate queue, and the site is appropriately updated.

At step 44, the source for content is identified and the content is ordered. (Netflix, other streaming source, in house library, or JPG2000 Hard Drive).

At step 46, an announcement is sent via social network sites and subscriber email, which will include the date and time of screening, a link to buy tickets, trailer view, and more information on the featured film.

At box 46, show times are added to the data base and published by deadline time/date to media outlets.

A link to buy tickets is provided at step 50, which includes the number of seats left and the format to be used for the showing (DVD, BluRay, HD or SD stream, hard drive, etc.)

At box 52, a second reminder is sent to the marketing list and the patron who booked the film.

An e-news weekly newsletter is updated and sent 54 by Web. This includes confirmed bookings and new or highlighted content.

A thank you email is sent at step 56 to the booking patron with a post-screening feedback inquiry.

A box office report is generated at box 58 with total ticket sales generated, and it is sent to the content/film license holder and/or provider.

Payment for the film rental license is generated at block 60, either by check or one or another kind of EFT transaction—wire transfer, payment card (credit or debit card), transaction involving stored value or electronic money, and so forth.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and method steps shown and described. Various modifications, alternative constructions, changes and equivalents will readily occur to those skilled in the art and may be employed, as suitable, without departing from the true spirit and scope of the invention. Therefore, the above description and illustrations should not be construed as limiting the scope of the invention, which is defined by the appended claims.

1. An interactive digital cinema and theater system, comprising:
at least one pre-fabricated auditorium room having at a plurality of seats and at least one space for a disabled person;
a wall-to-wall screen;
a multichannel digital sound system including a sound processor having a digital sound equalization system and a surround sound speaker system; and
a booking system for accepting and processing a general public booking for a featured digital event to be put on in said interactive digital cinema.

2. The interactive digital cinema and theater system of claim 1, further including connection means for combining two or more auditoriums into a single larger auditorium.

3. The interactive digital cinema and theater system of claim 1, wherein a plurality of auditorium rooms are combined and configured in a theater complex.

4. The interactive digital cinema and theater system of claim 1, further including a food concession.

5. The interactive digital cinema and theater system of claim 1, wherein said screen is a non-perforated solid silver screen.

6. The interactive digital cinema and theater system of claim 1, further including a pop-up seat disposed in a floor of said auditorium collocated at said at least one space for a disabled person.

7. The interactive digital cinema and theater system of claim 1, wherein said speaker surround sound speaker system includes speakers disposed in recesses in wall or ceiling panels.

8. The interactive digital cinema and theater system of claim 8, wherein said panels are acoustic panels.

9. The interactive digital cinema and theater system of claim 1, further including an adjustable cinema masking system

10. A method of processing and fulfilling a general public booking for a featured digital event to be put on at an interactive digital cinema, comprising:
(a) providing a digital theater as described in claim 1;
(b) providing an interactive medium through which patrons can book a time and place to view a feature film; and
(c) showing the film at the date and time booked by the patron.

11. The method of claim 10, wherein the interactive medium is a website, and further including the steps of:
(b1) presenting a listing of digital video events available for booking;
(b2) presenting a way for the patron to select the place, day, and time for the desired digital event to be held;
(b3) providing a secure site at which the patron may purchase tickets to the digital event;
(b4) accepting and processing a payment transaction;
(b5) confirming the pertinent licensing agreement with the digital event content provider;
(b6) sending a ticketing confirmation to an email address provided by the patron;
(b7) adding the title of the digital event scheduled to the event slate queue;
(b8) identifying the source or provider for the digital event content;
(b9) ordering the digital event content from the provider;
(b10) adding digital event times to a data base and publishing by a deadline time and date to media outlets.

12. The method of claim 11, further including (b11) providing a link to buy tickets, and providing information at the linked page including the number of seats available and the format to be used for the event.

13. The method of claim 11, further including the step of (b12) sending a reminder to a marketing list and to the patron who booked the film.

14. The method of claim 11, further including the step of (b3.1) presenting the patron with an inquiry as to whether the requested event will be exclusive or non-exclusive and accepting a reply from the patron.

15. The method of claim 11, further including (b10.1) sending an announcement and posting the availability of the screening to various social network sites.

16. The method of claim 11, further including (b13) sending an e-newsletter confirming bookings and new or highlighted content.

17. The method of claim 11, further including:
(b14) generating a box office report showing total ticket sales generated; and
(b15) sending the box office report to the content provider or license holder.

18. The method of claim 17, further including concluding a payment transaction to the digital content rental license.

19. The method of claim 10, wherein the interactive medium is selected from the group consisting of a personal computer, Internet-enabled connected mobile device, voice activated call center, and theatrical-on-demand service.

20. The method of claim 10, wherein the types of digital events presented at the digital theater are selected from the group consisting of films, on-line competitive gaming events, talk therapy sessions, and webinars.

21. (canceled)
